(19) United States
(12) Patent Application Publication
(10) Pub. No.: US 2015/0295655 A1
(43) Pub. Date: Oct. 15, 2015

(54) OPTICAL INTERCONNECTION ASSEMBLIES SUPPORTING MULTIPLEXED DATA SIGNALS, AND RELATED COMPONENTS, METHODS AND SYSTEMS

(71) Applicant: CORNING OPTICAL COMMUNICATIONS LLC, HICKORY, NC (US)

(72) Inventors: David Joseph Hessong, Hickory, NC (US); Brian Keith Rhoney, Hickory, NC (US)

(21) Appl. No.: 14/677,098

(22) Filed: Apr. 2, 2015

Related U.S. Application Data
(60) Provisional application No. 61/977,686, filed on Apr. 10, 2014.

(51) Int. Cl. H04B 10/27; H04J 14/00

(52) U.S. Cl. CPC H04B 10/27; H04J 14/00

(57) ABSTRACT

To minimize cabling in a spine-and-leaf network, optical interconnection assemblies and related components, methods and systems disclosed herein have a plurality of spine-side multiplexer/demultiplexer pairs for communicating multiplexed communications signals between the optical interconnection assembly and one or more spine switches, and a plurality of leaf-side multiplexer/demultiplexer pairs for communicating multiplexed communications signals between the optical interconnection assembly and one or more leaf switches. Within the optical interconnection assembly, each spine-side demultiplexer is connected to every leaf-side multiplexer via at least one path, and each leaf-side demultiplexer is connected to every spine-side multiplexer via at least one path. In this manner, the optical interconnection assembly provides at least one discrete channel from each leaf switch to every spine switch, and vice versa. Also in this manner, each spine switch is connected directly to the optical interconnection assembly, and each leaf switch is also connected directly to the optical interconnection assembly.

### PRIORITY APPLICATION

This application claims the benefit of priority under 35 U.S.C. §119 of U.S. Provisional Application Serial No. 61/977,686 filed on Apr. 10, 2014, the content of which is relied upon and incorporated herein by reference in its entirety.

### RELATED APPLICATIONS

This application is related to U.S. patent application Ser. No. 14/177,443 filed Feb. 11, 2014, the content of which is incorporated herein by reference in its entirety.

### BACKGROUND

1. Field

The present disclosure relates to spine-and-leaf networks, and in particular relates to optical interconnection assemblies for use in spine-and-leaf network networks that facilitate scale-out.

2. Technical Background

A data center is a location that houses computers and related telecommunications equipment and components for the purpose of processing (e.g., receiving, storing, managing and transmitting) data. Data centers often need to be expanded or “scaled out,” wherein hardware is added to accommodate the increasing data-processing demands. It is thus desirable that the data-center hardware be configured in a manner that is scalable, i.e., that can support scale-out of the hardware such that the data-processing performance of the data center improves in direct proportion to the added capacity.

Traditional data-center architectures have relied on a three-tier switching architecture whereby network reliability and scale-out capability is accomplished through switch redundancy. However, the three-tier switching architecture is not optimal for certain types of data centers, such as Internet data centers, that process relatively large amounts of data.

One type of network architecture that is well-suited for use in high-capacity data centers is called a “spine-and-leaf” (S/L) architecture, which flattens the network to reduce latency and simplifies redundancy. In this regard, FIG. 1 illustrates a schematic diagram of an S/L network 10 illustrating the added complexity of scaling out the S/L network 10. The S/L network 10 defines a network fabric 12 that interconnects leaf switches 14 and spine switches 16. The S/L network 10 in FIG. 1 requires that every leaf switch 14 be connected to every spine switch 16 to define the network fabric 12 (also referred to as a network mesh). Thus, adding a new switch, such as spine switch 16(4), to the S/L network 10 to further scale out the S/L network requires connecting the spine switch 16(4) directly to each of leaf switches 14(1)-14(4), thereby increasing cabling complexity.

The ability to scale-out the S/L network 10 also depends on the data rates employed, e.g., ten (10) Gigabit Ethernet (10-GbE) or forty (40) GbE. Presently, many spine-switch components and leaf-switch connection components are rated for a 40 GbE data rate. However, a 40-GbE mesh would limit the network's ability to be scaled out because many leaf switches support only four 40-GbE uplink connection components to interface with the spine switch, which effectively limits the network to four spine switches. As a result, because the number and bandwidth of client connections is limited by the bandwidth capacity of the spine switches, this effectively limits the overall connection capacity of the S/L network 10.

One approach to overcoming this type of scale-out limitation involves creating a 10-GbE mesh to allow for four (4) times the amount of scale-out capability, i.e., sixteen 10-GbE connection components that allow for sixteen (16) spine switches, as opposed to provide four (4) 40-GbE connection components that limits the mesh to a maximum of four (4) spine switches. This 10-GbE mesh can be created by using cabling in the form of fiber optic cable jumpers terminated with LC duplex connectors to break out each 40-GbE connection component into 4×10-GbE connection components to obtain the sixteen (16) 10-GbE connection components. However, this creates cabling complexity because the number of individually routed 10-GbE optical fibers continues to increase exponentially as additional spine switches are added. At the same time, each optical fiber is potentially routed to a unique switch, thus defeating one of the advantages of the high-bandwidth connection components of the spine and leaf switches.

No admission is made that any reference cited herein constitutes prior art. Applicant expressly reserves the right to challenge the accuracy and pertinence of any cited documents.

### SUMMARY

Embodiments include optical interconnection assemblies supporting multiplexed data signals for providing network connectivity to a plurality of servers, clients and/or other computing devices. Related components, methods, and systems are also disclosed. For example, a spine-and-leaf (S/L) network requires that each spine switch be communicatively connected to every leaf switch in the network, and vice versa. However, as additional switches are added to a S/L network, cabling complexity increases exponentially, because individual connections must be made between each new spine/leaf switch combination. In accordance with exemplary embodiments disclosed herein, multiple channels can be provided from a spine or leaf switch to a central optical interconnection assembly using a single multiplexed signal from each spine and leaf switch. In this manner, the optical interconnection assemblies disclosed herein can be employed in a S/L network to provide a desired spine-leaf fabric that can be more easily scaled while minimizing cabling complexity to and from each individual spine and leaf switch.

To minimize cabling, exemplary optical interconnection assemblies disclosed herein have a plurality of spine-side multiplexer/demultiplexer pairs for communicating multiplexed communications signals between the optical interconnection assembly and one or more spine switches. The optical interconnection assemblies also have a plurality of leaf-side multiplexer/demultiplexer pairs for communicating multiplexed communications signals between the optical interconnection assembly and one or more leaf switches. Within the optical interconnection assembly, each spine-side demultiplexer is connected to every leaf-side multiplexer via at least one path, and each leaf-side demultiplexer is connected to every spine-side multiplexer via at least one path. In this manner, the optical interconnection assembly provides at least one discrete channel from each leaf switch to every spine switch, and vice versa. Also in this manner, each spine switch is connected directly to the optical interconnection assembly, and each leaf switch is also connected directly to the optical interconnection assembly.

Each leaf-side demultiplexer receives a leaf-side downlink signal from the leaf switch and demultiplexes the leaf-side downlink signal into a plurality of component downlink signals. For downlink signals, which travel in a leaf-to-spine direction (e.g., from leaf-connected servers to spine switches), the leaf-side demultiplexer provides at least one component downlink signal to every spine-side multiplexer, such that each spine-side multiplexer receives at least one component downlink signal from every leaf-side demultiplexer. Each spine-side multiplexer then multiplexes the downlink component signals received from the plurality of leaf-side demultiplexers into a spine-side downlink signal and provides the spine-side downlink signal to one of the spine switches. For uplink signals, which travel in a spine-to-leaf direction (e.g., from spine switches to leaf-connected servers), the spine-side demultiplexers distribute spine-side uplink signals received from the spine switches to the leaf-side multiplexers in a similar manner, such that each leaf-side multiplexer receives at least one component uplink signal from every spine-side demultiplexer. Each leaf-side multiplexer multiplexes the received uplink component signals into a respective leaf-side uplink signal and provides the leaf-side downlink signal to one of the leaf switches.

In this manner, the self-contained optical interconnection assembly permits additional spine and leaf switches to be more easily integrated into a network by connecting the spine and leaf switches directly to the optical interconnection assembly, as opposed to directly connecting each new spine to each additional leaf individually. Thus, the self-contained optical interconnection assembly reduces cabling complexity during network build-out, while maintaining increased scalability of the network.

One embodiment of the disclosure relates to an optical interconnection assembly for directing communication signals between spine and leaf connection components of a spine-and-leaf network. The optical interconnection assembly comprises a plurality of leaf-side demultiplexers, each having a leaf-side demultiplexer input and a plurality of leaf-side demultiplexer outputs. The optical interconnection assembly further comprises a plurality of spine-side multiplexers, each having a plurality of spine-side multiplexer inputs and a spine-side multiplexer output. The optical interconnection assembly further comprises a plurality of downlink optical paths. Each of the plurality of downlink optical paths is optically connected between a leaf-side demultiplexer output to a spine-side multiplexer input. Each spine-side multiplexer is configured to receive a component downlink signal on a downlink optical path from every leaf-side demultiplexer and multiplex the received component downlink signals into a multiplexed spine-side downlink signal.

Another embodiment of the disclosure relates to a spine and leaf (S/L) network comprising at least one leaf switch each having a plurality of leaf connection components, a plurality of spine switches each having a plurality of spine connection components, and at least one optical interconnection assembly for directing communication signals between spine and leaf connection components of the spine-and-leaf network. Each optical interconnection assembly comprises a plurality of leaf-side demultiplexers each having a leaf-side demultiplexer input and a plurality of leaf-side demultiplexer outputs. Each optical interconnection assembly further comprises a plurality of spine-side multiplexers, each having a plurality of spine-side multiplexer inputs and a spine-side multiplexer output. Each optical interconnection assembly further comprises a plurality of downlink optical paths. Each of the plurality of downlink optical paths is optically connected between a leaf-side demultiplexer output to a spine-side multiplexer input such that each leaf-side demultiplexer is optically connected to every spine-side multiplexer by at least one downlink optical path. Each spine-side multiplexer is configured to receive a component downlink signal on a downlink optical path from every leaf-side demultiplexer and multiplex the received component downlink signals into a multiplexed spine-side downlink signal.

Another embodiment of the disclosure relates to a method of directing communication signals between spine and leaf connection components of a spine-and-leaf network. The method comprises receiving a multiplexed leaf-side downlink signal from a leaf connection component at one of a plurality of leaf-side demultiplexer inputs of a plurality of leaf-side demultiplexers of an optical interconnection assembly. The method further comprises demultiplexing each multiplexed leaf-side downlink signal into a plurality of component downlink signals. The method further comprises providing each of the plurality of component downlink signals to a different one of a plurality of downlink optical paths of the optical interconnection assembly via one of a plurality of leaf-side demultiplexer outputs of the optical interconnection assembly. The method further comprises receiving a component downlink signal at each one of a plurality of spine-side multiplexer inputs of a plurality of spine-side multiplexers of the optical interconnection assembly via a downlink optical path from one of the leaf-side demultiplexers. Each spine-side multiplexer receives a component downlink signal from every one of the plurality of leaf-side demultiplexers. The method further comprises multiplexing, at each spine-side multiplexer, the received component downlink signals into a multiplexed spine-side downlink signal. The method further comprises providing each multiplexed spine-side downlink signal to a spine connection component at the spine-side multiplexer output.

Another embodiment of the disclosure relates to an optical interconnection assembly for directing communication signals between spine and leaf connection components of a spine-and-leaf network. The optical interconnection assembly comprises a plurality of spine-side demultiplexers, each having a spine-side demultiplexer input and a plurality of spine-side demultiplexer outputs. The optical interconnection assembly further comprises a plurality of leaf-side multiplexers, each having a plurality of leaf-side multiplexer inputs and a leaf-side multiplexer output. The optical interconnection assembly further comprises a plurality of uplink optical paths. Each of the plurality of uplink optical paths is optically connected between a spine-side demultiplexer output to a leaf-side multiplexer input. Each leaf-side multiplexer is configured to receive a component uplink signal on an uplink optical path from every spine-side demultiplexer and multiplex the received component uplink signals into a multiplexed leaf-side uplink signal.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of a spine and leaf (S/L) network, illustrating the added complexity of adding additional spine and/or leaf switches to the network;

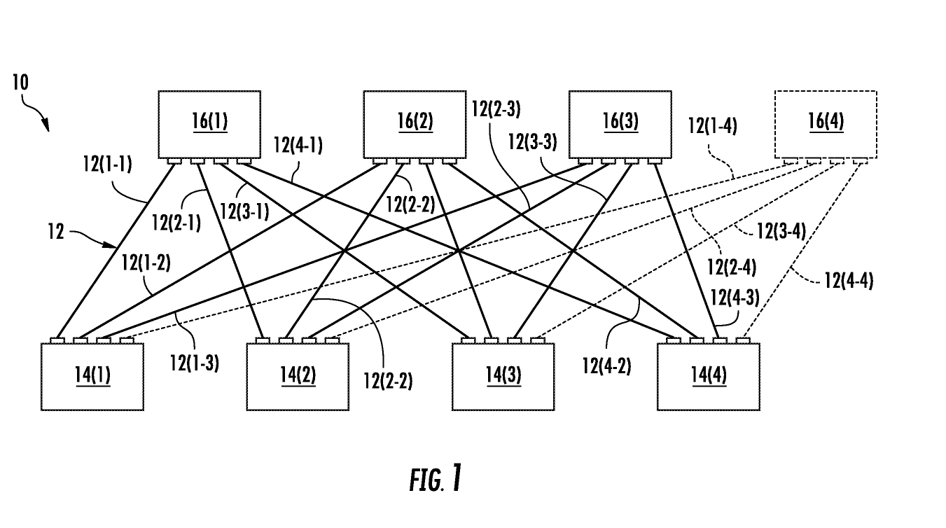

FIG. 2 is a schematic diagram of an example S/L network that includes two spine switches and two leaf switches optically connected via two optical fiber interconnection assemblies in a 4×4 scale-out configuration;

FIG. 3A is a schematic diagram of an exemplary optical interconnection assembly according to the disclosure, showing a detailed view of a portion of an exemplary harness or optical fiber array to illustrate connecting one leaf-side multiplexer/demultiplexer pair to every spine-side multiplexer/demultiplexer pair;

FIG. 3B is a schematic diagram of the optical interconnection assembly of FIG. 3A, further illustrating connecting one spine-side multiplexer/demultiplexer pair to every leaf-side multiplexer/demultiplexer pair;

FIG. 3C is a schematic diagram of the optical interconnection assembly of FIGS. 3A and 3B, further illustrating connecting another spine-side multiplexer/demultiplexer pair to every leaf-side multiplexer/demultiplexer pair, and another leaf-side multiplexer/demultiplexer pair to every spine-side multiplexer/demultiplexer pair;

FIG. 3D is a schematic diagram of the optical interconnection assembly of FIGS. 3A-3C, further illustrating connecting the remaining spine-side multiplexer/demultiplexer pairs to every leaf-side multiplexer/demultiplexer pair, and the remaining leaf-side multiplexer/demultiplexer pairs to every spine-side multiplexer/demultiplexer pair;

FIG. 4A is similar to FIG. 2 and shows an example of the S/L network of FIG. 2 as scaled out to include two additional spine switches;

FIG. 4B is similar to FIG. 4A and shows an example of the S/L network of FIG. 4A as scaled out to include a total of eight spine switches that connect to two leaf switches through two optical interconnection assemblies; and

FIG. 5 is a cut-away view of a generalized optical interconnection assembly.

### DETAILED DESCRIPTION

Various embodiments will be further clarified by the following examples.

Embodiments include optical interconnection assemblies supporting multiplexed data signals for providing network connectivity to a plurality of servers, clients and/or other computing devices. Related components, methods, and systems are also disclosed. To minimize cabling, exemplary optical interconnection assemblies disclosed herein have a plurality of spine-side multiplexer/demultiplexers for communicating multiplexed communications signals between the optical interconnection assembly and one or more spine switches. The optical interconnection assemblies also have a plurality of leaf-side multiplexer/demultiplexers for communicating multiplexed communications signals between the optical interconnection assembly and one or more leaf switches. Within the optical interconnection assembly, each spine-side demultiplexer is connected to every leaf-side multiplexer via at least one path, and each leaf-side demultiplexer is connected to every spine-side multiplexer via at least one path. In this manner, the optical interconnection assembly provides at least one discrete channel from each leaf switch to every spine switch, and vice versa. Also in this manner, each spine switch is connected directly to the optical interconnection assembly, and each leaf switch is also connected directly to the optical interconnection assembly.

Each leaf-side demultiplexer receives a leaf-side downlink signal from the leaf switch and demultiplexes the leaf-side downlink signal into a plurality of component downlink signals. For downlink (i.e., leaf-to-spine) signals, the leaf-side demultiplexer provides at least one component downlink signal to every spine-side multiplexer, such that each spine-side multiplexer receives at least one component downlink signal from every leaf-side demultiplexer. Each spine-side multiplexer then multiplexes the downlink component signals received from the plurality of leaf-side demultiplexers into a spine-side downlink signal and provides the spine-side downlink signal to one of the spine switches. For uplink (i.e., spine-to-leaf) signals, the spine-side demultiplexers distribute spine-side uplink signals received from the spine switches to the leaf-side multiplexers in a similar manner, such that each leaf-side multiplexer receives at least one component uplink signal from every spine-side demultiplexer. Each leaf-side multiplexer multiplexes the received uplink component signals into a respective leaf-side uplink signal and provides the leaf-side downlink signal to one of the leaf switches.

In this manner, the self-contained optical interconnection assembly permits additional spine and leaf switches to be more easily integrated into a network by connecting the spine and leaf switches directly to the optical interconnection assembly, as opposed to directly connecting each new spine to each additional leaf individually. Thus, the self-contained optical interconnection assembly reduces cabling complexity during network build-out, while maintaining increased scalability of the network.

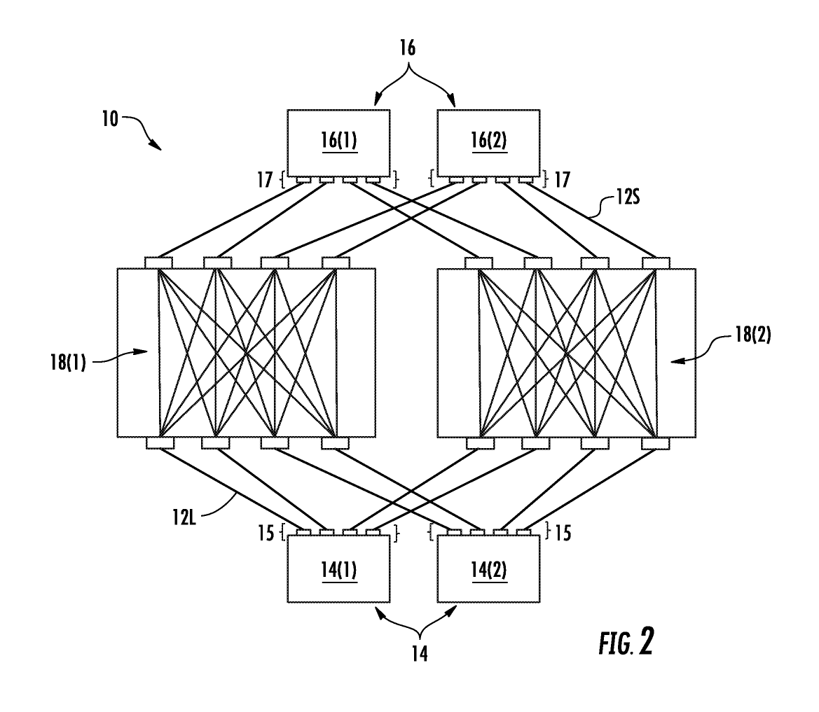

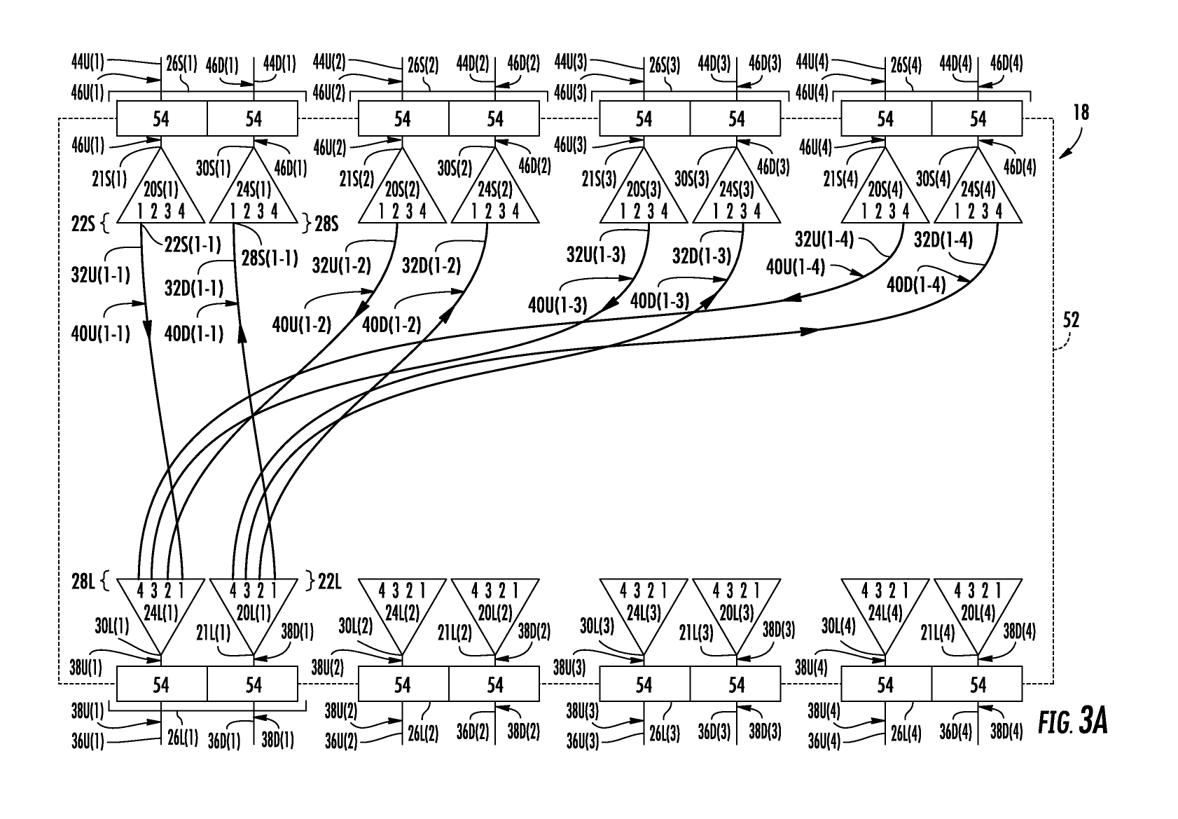

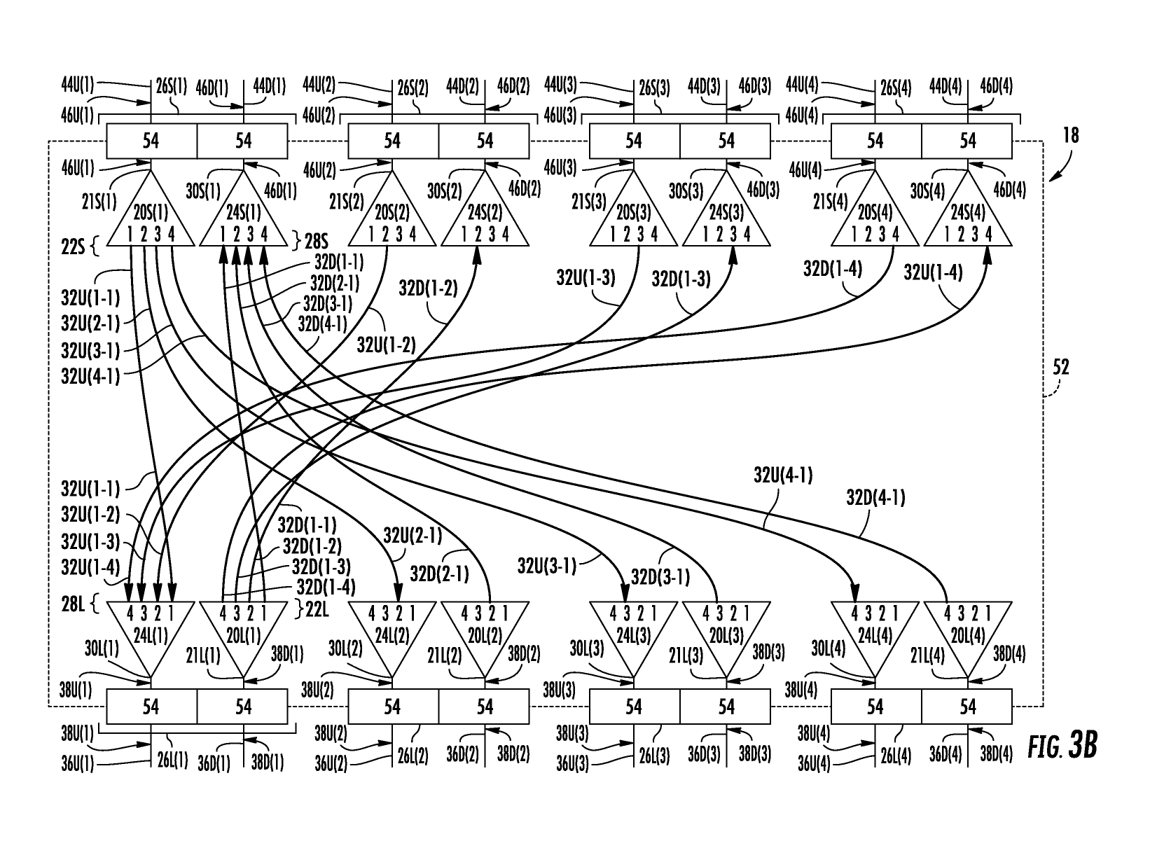

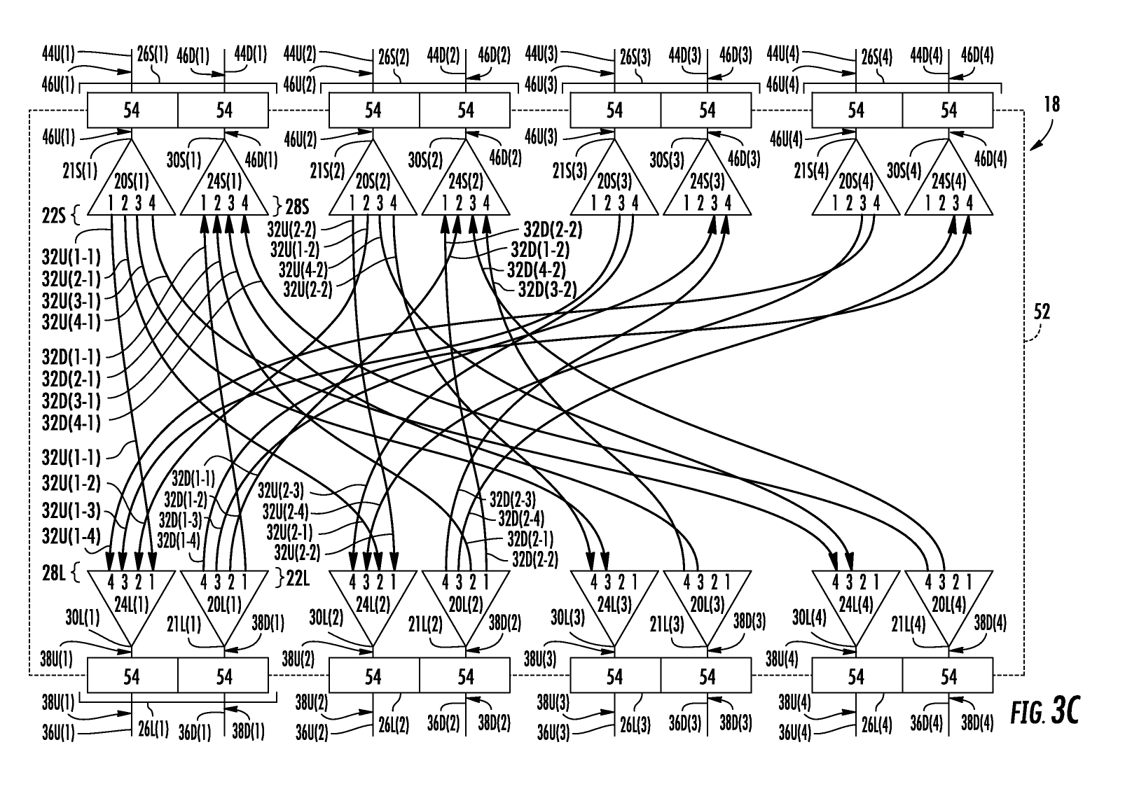

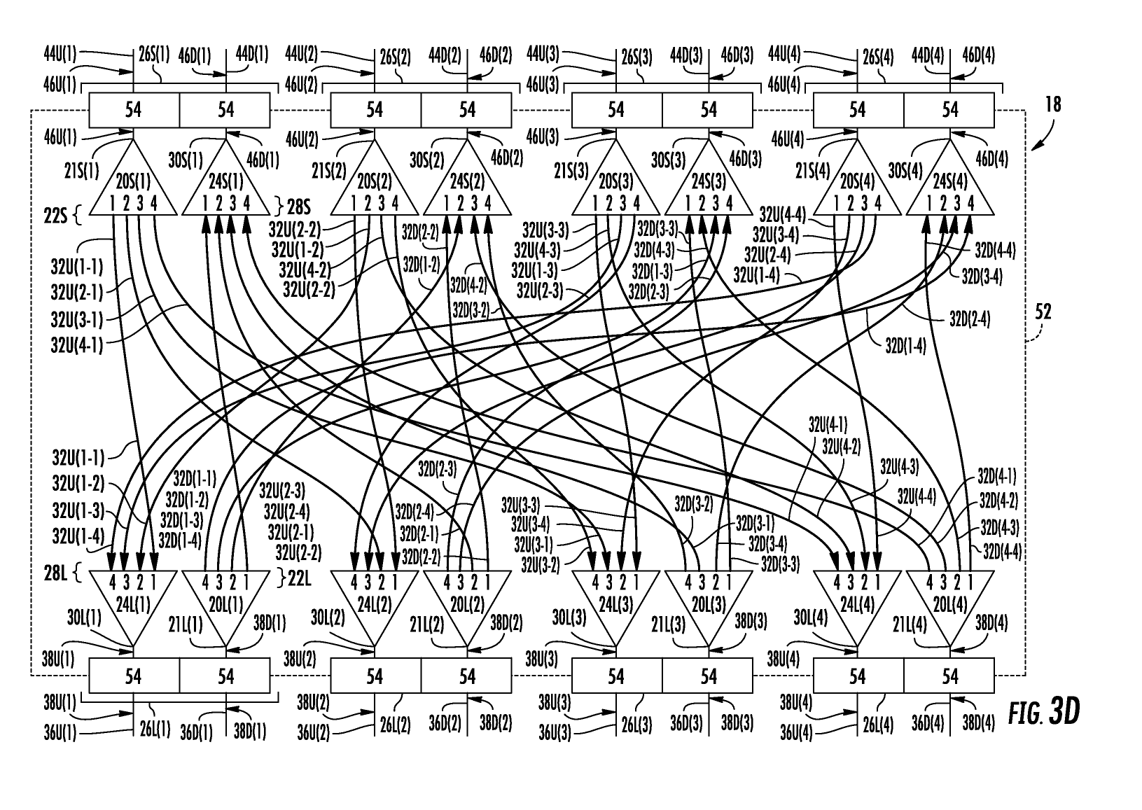

One embodiment of the disclosure relates to an optical interconnection assembly for directing communication signals between spine and leaf connection components of a spine-and-leaf network. In this regard, FIG. 2 illustrates a schematic diagram of an example S/L network 10 and a detailed schematic diagram of used in the S/L network. The S/L network 10 includes one or more leaf switches 14 each having one more leaf connection components 15, one or more spine switches 16 each having one or more spine connection components 17, and one or more exemplary optical interconnection assemblies 18. In this example, the two spine switches 16 and two leaf switches 14 are optically connected to each other via the two optical interconnection assemblies 18 in a 4×4 scale-out configuration. As can be seen, each spine switch 16 is connected directly to the spine side of the optical interconnection assembly 18, and each leaf switch 14 is connected directly to the leaf side of the optical interconnection assembly 18. As will be described in greater detail with respect to FIGS. 3A-3D, the optical interconnection assembly 18 is configured to demultiplex incoming signals received at the leaf side of the optical interconnection assembly 18 from the leaf switches 14 into component signals. The optical interconnection assembly 18 next directs at least one component signal from each leaf switch 14 to every spine switch 16 connected to the spine side of the optical interconnection assembly 18. All component signals directed to a particular spine switch 16 are then re-multiplexed into a multiplexed signal and directed to the respective spine switch 16. A similar process occurs for signals travelling in the spine-to-leaf direction through the optical interconnection assembly 18.

In the example embodiment of FIG. 2, the spine-and-leaf (S/L) network 10 includes two spine switches 16 (16(1) and 16(2)) and two leaf switches 14 (14(1) and 14(2)) in a 4×4 scale-out configuration. In the present example, each spine switch 16 has four spine connection components 17, and each leaf switch 14 has four leaf connection components 15. Each of the spine connection components 17 and each of the leaf connection components 15 are 40 GbE parallel optic connection components. Thus, all spine switches 16 (i.e., 16(1) and 16(2)) and all leaf switches 14 (i.e., 14(1) and 14(2)) in the exemplary S/L network 10 of FIG. 2 have multiple 40 GbE connection components.

In the exemplary S/L network 10 of FIG. 2, spine switches 16 and leaf switches 14 are connected through two optical interconnection assemblies 18 (18(1) and 18(2)). It should be understood, however, that various examples of S/L networks 10 such as those shown in FIG. 2 and in the other figures are simplified representations for ease of illustration and discussion. For example, the S/L network 10 of FIG. 2 can be scaled out to have tens, hundreds or thousands of optical interconnection assemblies 18, as needed. In addition, S/L network 10 can have tens of spine switches 16, with each of the spine switches having hundreds of spine connection components 17. Moreover, spine switches 16 can be meshed with hundreds, or thousands, of leaf switches 14 that each has tens of leaf connection components 15. Likewise, example S/L networks 10 may utilize tens, hundreds or thousands of optical interconnection assemblies 18 to create the required mesh.

Referring now to FIG. 3A, a schematic diagram of an exemplary optical interconnection assembly according to the disclosure is illustrated, showing the connections required to connect a single leaf switch 14 (not shown) to a plurality of spine switches 16 (not shown). Each optical interconnection assembly 18 comprises a plurality of leaf-side demultiplexers 20L(1)-20L(4) each having a leaf-side demultiplexer input 21L and a plurality of leaf-side demultiplexer outputs 22L. The optical interconnection assembly 18 further comprises a plurality of spine-side multiplexers 24S(1)-24S(4). Each leaf-side demultiplexer 20L is paired with a complementary leaf-side multiplexer 24L as part of a leaf-side multiplexer/demultiplexer pair 26L and each spine-side multiplexer 24S is paired with a corresponding spine-side demultiplexer 20S as part of a spine-side multiplexer/demultiplexer pair 26S. Referring back to the spine-side multiplexers 24S, each spine-side multiplexer 24S has a plurality of spine-side multiplexer inputs 28S and a spine-side multiplexer output 30S. Thus, in this example, the optical interconnection assembly 18 of FIG. 3A has four spine-side multiplexer/demultiplexer pairs 26S(1)-26S(4) and four leaf-side multiplexer/demultiplexer pairs 26L(1)-26L(4). In this embodiment, the multiplexer/demultiplexer pairs 26L/S are wave-division multiplexer/demultiplexer pairs that use wave division multiplexing (WDM), for example coarse wave-division multiplexing (CWDM), to multiplex and demultiplex the different optical signals. It should be understood, however, that other methods of multiplexing/demultiplexing may also be used, such as time-division multiplexing, for example. In this embodiment, the multiplexer 24L/S and demultiplexer 20L/S of each multiplexer/demultiplexer pair 26L/S are not part of an integrated assembly or subassembly, but in other embodiments, multiplexer/demultiplexer pairs 26L/S could be so integrated.

The optical interconnection assembly 18 further comprises a plurality of downlink optical paths 32D. In the example of FIGS. 3A-3D, the downlink optical paths 32D (and complementary uplink optical paths 32U) each comprise one or more optical fibers. In one example, optical fibers in the plurality of optical paths 32D/U (also referred to herein as a “harness or optical fibers” or “harness”) are single mode, while in another example the optical fibers are multimode. Each of the plurality of downlink optical paths 32D is optically connected between a leaf-side demultiplexer output 22L and a spine-side multiplexer input 28S. As used herein, the numbering convention used for demultiplexer outputs 22L/S, multiplexer inputs 28L/S, and optical paths 32D/U includes a numerical (M-N) suffix referring to the specific leaf-side to spine-side connection. The M digit refers to the respective leaf-side connection, and the N digit refers to the respective spine-side connection. Thus, for example, leaf-side demultiplexer output 22L(1-2), spine-side multiplexer input 28S(1-2), and downlink optical path 32D(1-2) all refer to the connection between leaf-side multiplexer/demultiplexer pair 26L(1) and spine-side multiplexer/demultiplexer pair 26S(2).

In this embodiment, each multiplexed leaf-side downlink signal is comprised of four different wavelengths, which output to the four (4) respective leaf-side demultiplexer outputs 22L of each leaf-side demultiplexer 24L. In this embodiment, each spine-side multiplexer input 28S also receives one component downlink signal 40D of each of the four wavelengths, so that the different component downlink signals 40D can be re-multiplexed into the spine-side downlink multiplexed signal without interfering with each other.

In this regard, each numbered multiplexer input 28S/L and demultiplexer output 22S/L refers to a specific wavelength (λ1-4). In other words, each demultiplexer 20S/L is configured to receive and demultiplex a multiplexed input signal 38D/46U having four component signals 40D/U on wavelengths 1-4. Each demultiplexer 20S/L outputs component signals 40 D/U having λ 1 to output 1, component signals 40 D/U having λ 2 to output 2, component signals 40 D/U having λ 3 to output 3, and component signals 40 D/U having λ 4 to output 4. Likewise, each multiplexer 24S/L is configured to receive component signals 40 D/U having λ 1 at input 1, component signals 40 D/U having λ 2 at input 2, component signals 40 D/U having λ 3 at input 3, and component signals 40 D/U having λ 4 at input 4. The received component signals 40D/U are then multiplexed into a single multiplexed output signal 38U/46D.

Thus, by connecting each demultiplexer output 22L/S to a multiplexer input 28L/S of the same wavelength (λ 1-4), and vice versa, it is ensured that the individual component signals 40D/U will not interfere with each other when they are multiplexed back into their respective output signals 38U/46D.

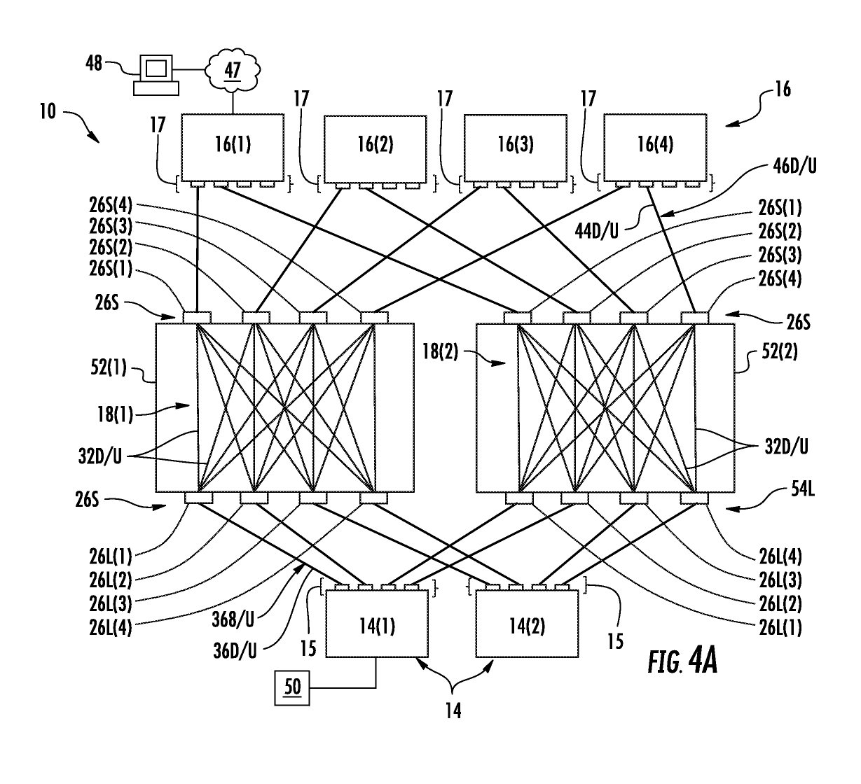

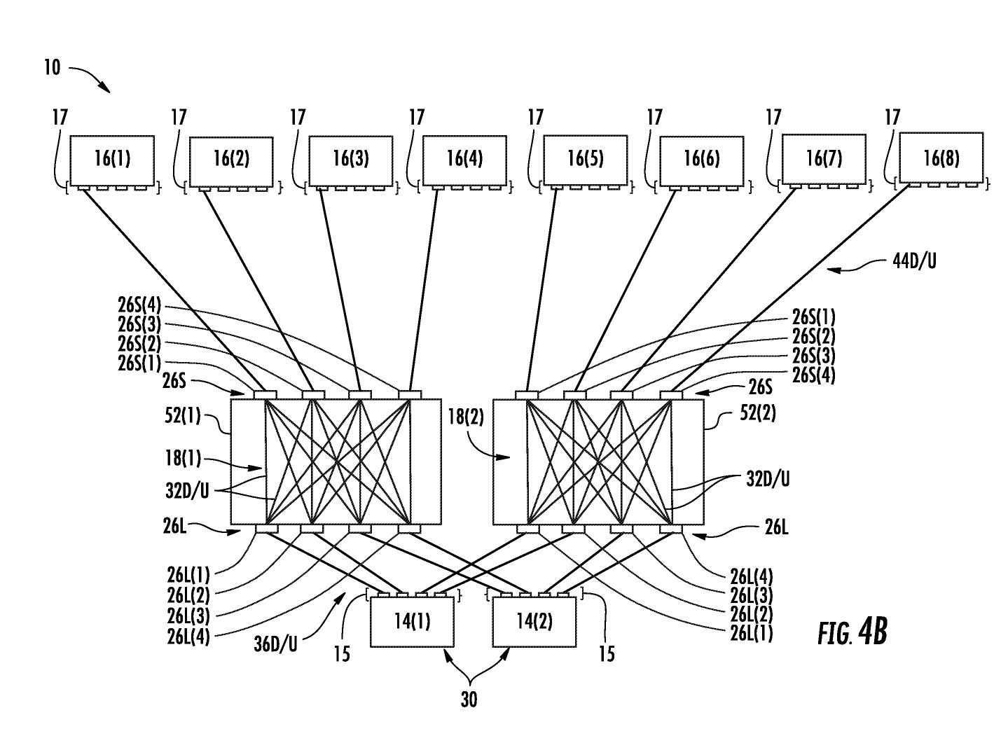

Referring back to FIG. 3A, the first leaf-side demultiplexer 20L(1) is optically connected to every spine-side multiplexer 24S by at least one downlink optical path 32D. A leaf connection component 15 (see FIG. 4A) of leaf switch 14(1) is connected to the leaf-side demultiplexer 20L(1) via a leaf-side downlink optical path 36D. Leaf-side demultiplexer 20L receives a multiplexed leaf-side downlink signal 38D at the leaf-side demultiplexer input 21L and demultiplexes the multiplexed leaf-side downlink signal 38D into a plurality of component downlink signals 40D, each having a different wavelength (λ 1-4). Leaf-side demultiplexer 20L(1) is further configured to provide each of the plurality of component downlink signals 40D to a different one of the plurality of downlink optical paths 32D via one of the plurality of leaf-side demultiplexer outputs 22L.

Each spine-side multiplexer 24S is optically connected to leaf-side multiplexer 20L(1) by at least one downlink optical path 32D, and is also connected to a spine connection component 17 (see FIG. 4A) of a spine switch 16 via a spine-side downlink optical path 44D. Each spine-side multiplexer 24S receives a component downlink signal 40D at a respective spine-side multiplexer input 28S via a downlink optical path 32D from the leaf-side demultiplexer 20L(1). As will be illustrated in FIGS. 3B-3D, each spine-side multiplexer 24S receives a component downlink signal 40D from every one of the plurality of leaf-side demultiplexers 20L. Each spine-side multiplexer 24S next multiplexes the received component downlink signals 40D into a multiplexed spine-side downlink signal 46D and provides the multiplexed spine-side downlink signal 46D to a spine connection conent 17 (see FIG. 4A) at the spine-side multiplexer output 30S.

Referring now to FIG. 3B, the connection of spine-side multiplexer/demultiplexer pair 26S(1) to every leaf-side multiplexer/demultiplexer pair 26L is illustrated. The connection scheme is consistent with the scheme shown in FIG. 3A, with each spine-side demultiplexer output 22S being connected to a leaf-side multiplexer input 28L corresponding to the same wavelength (λ 1-4). FIG. 3C illustrates connecting a second spine-side multiplexer/demultiplexer pair 26S(2) to every leaf-side multiplexer/demultiplexer pair 26L, and a second leaf-side multiplexer/demultiplexer pair 26L(2) to every spine-side multiplexer/demultiplexer pair 26S. As with FIGS. 3A and 3B, each spine-side demultiplexer output 22S is connected to a leaf-side multiplexer input 28L corresponding to the same wavelength (λ 1-4). Finally, FIG. 3D illustrates connecting the last spine-side multiplexer/demultiplexer pairs 26S(3) and 26S(4) to every leaf-side multiplexer/demultiplexer pair 26L, and the remaining leaf-side multiplexer/demultiplexer pairs 26L(3) and 26L(4) to every spine-side multiplexer/demultiplexer pair 26S. Thus, it can be seen that each spine side multiplexer/demultiplexer pair 26S is connected to every leaf-side multiplexer/demultiplexer pair 26L, and vice versa. Further, it can be seen that every demultiplexer output 22S/L is connected to a multiplexer input 28S/L corresponding to the same wavelength (λ 1-4) as the respective demultiplexer output 22S/L.

With continuing reference to FIGS. 3A-3D, the optical interconnection assembly 18 in this embodiment includes complementary hardware to provide uplink communications in the same manner as providing downlink communications described above. A multiplexed spine-side uplink signal 46U may be received from a spine connection component 17 (see FIG. 4A) at a spine-side demultiplexer input 21S of a plurality of spine-side demultiplexers 20S of the optical interconnection assembly 18. Each spine-side demultiplexer 20S then demultiplexes each multiplexed spine-side uplink signal 46U into a plurality of component uplink signals 40U, and provides each of the plurality of component uplink signals 40U to a different one of a plurality of uplink optical paths 32U of the optical interconnection assembly 18 via one of a plurality of spine-side demultiplexer outputs 22S. Each leaf-side multiplexer input 28L receives a component uplink signal 40U via an uplink optical path 32U from one of the spine-side demultiplexers 20S, such that each leaf-side multiplexer 24L receives a component uplink signal 40U from every one of the plurality of spine-side demultiplexers 20S. Each leaf-side multiplexer 24L then multiplexes the received component uplink signals 40U into a multiplexed leaf-side uplink signal 38U, and provides the multiplexed leaf-side uplink signal 38U to a leaf connection component 15 via the leaf-side multiplexer output 30L of the leaf-side multiplexer 24L.

In this manner, parallel uplink and downlink signals can be communicated between any leaf switch 14 and any spine switch 16, while minimizing cabling complexity. Because only one fiber optic connection is required between each leaf switch 14 or spine switch 16 and the optical interconnection assembly 18, additional spine switches 16 can be added to the S/L network 10, without manually connecting each new spine switch 16 to every leaf switch 14, or vice versa.

The optical interconnection assembly 18 of FIGS. 2 and 3A-3D can employ a variety of hardware configurations and/or form-factors. In this example, each optical interconnection assembly 18 may be housed in a fiber optic module 52, but other form-factors are also possible, including, without limitation, a furcated cable or other assembly.

In this example, spine connection components 17 of each spine switch 16 are optically connected to spine-side multiplexer/demultiplexer pair 26S of optical interconnection assemblies 18 via one or more optical-fiber cables (i.e., spine-side optical paths 44D/U) while leaf connection components 15 of each leaf switch 14 are optically connected to leaf-side multiplexer/demultiplexer pairs 26L of the optical interconnection assemblies 18 via one or more optical-fiber cables (i.e., leaf-side optical paths 36D/U). In this embodiment, each of the spine-side and leaf-side multiplexer/demultiplexer pair 26S/L is connected to one or more fiber optic adapters 54, which are each configured to receive and optically connect optical-fiber cables 44D/U and 36D/U to the interconnection assembly 18. The optical-fiber cables 44D/U and 36D/U may be relatively short in some embodiments, and may also be referred to hereinafter as “patch cords” or “jumpers” as the term is used in the industry. In the present example, patch cords 44D/U and 36D/U are each 40 GbE.

In order for S/L network 10 to be fully meshed at 40 GbE, at least one spine connection component 17 of each spine switch 16 needs to be connected to at least one leaf connection component 15 of each leaf switch 14. Put another way, each spine switch 16 is connected to every leaf switch 14. The configuration of optical-fiber array 32D/U (also called a “harness”) in each optical interconnection assembly 18 defines a mesh that serves to connect at least one spine connection component 17 to at least one leaf connection component 15 in a manner that makes S/L network 10 more easily scalable without reducing the patch-cord cabling to 10 GbE and without adding additional cabling complexity.

In this regard, FIG. 4A illustrates an example of the S/L network 10 of FIG. 2 scaled-out to include two additional spine switches 16, denoted 16(3) and 16(4). Notably, the addition of spine switches 16(3) and 16(4) does not require that the configuration of leaf patch cords 36D/U to be changed. Instead, spine patch cords 44D/U are adjusted as shown so that each spine switch 16 is connected to each leaf switch 14 via the two optical interconnection assemblies 18. In this manner, any number of spine switches 16 in the S/L network 10 may be connected to an external network 47, such as a WAN connected to the Internet, thereby allowing one or more client computers 48 or other computing devices to communicate with one or more servers 50 or other computing devices connected to one or more of the leaf switches 14 in the S/L network 10. Regardless of the number of individual spine switches 16 or leaf switches 14, a connected client computer 48 will always be able to receive a downlink signal from a server 50.

FIG. 4B similarly illustrates the exemplary S/L network 10 of FIG. 4A scaled-out to include a total of eight spine switches 16, i.e., switches 16(1) through 16(8), with one spine connection component 17 of each spine switch 16 connected to one spine-side multiplexer/demultiplexer pair 26S of one of the two optical interconnection assemblies 18, as shown.

To accomplish the scale-out of S/L network 10 of FIG. 4B, additional spine patch cords 44D/U are connected the added spine switches 16(5) through 16(8) to spine-side multiplexer/demultiplexer pairs 26S of optical interconnection assemblies 18. This has the added advantage of freeing up spine connection components 17 on switches 16(1) through 16(4), allowing connectivity from additional leaf connection components 15.

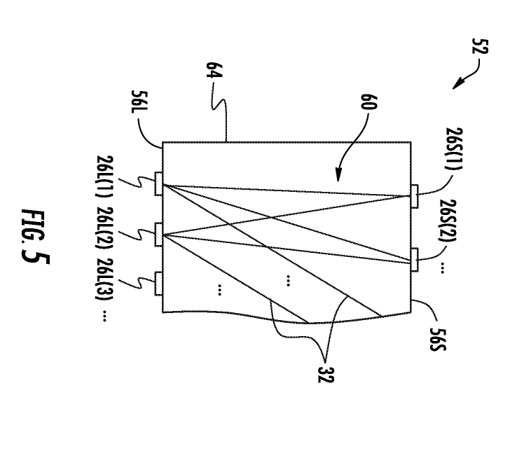

It should be understood from the above examples that the optical interconnection assembly 18 is not limited to a “4×4” configuration. In this regard, FIG. 5 is a cut-away view of a generalized optical interconnection assembly 60 that provides for any number of spine-side multiplexer/demultiplexer pairs 26S and/or leaf-side multiplexer/demultiplexer pairs 26L. As with optical interconnection assembly 18 described above, optical interconnection assembly 60 may reside in S/L network 10 between spine switches 16 and leaf switches 14 and may serve to optically interface spine connection components 17 of the spine switches 16 and leaf connection components 15 of the leaf switches 14. The optical interconnection assembly 60 has a number M_{S} of spine-side multiplexer/demultiplexer pairs 26S and a number M_{L} of leaf-side multiplexer/demultiplexer pairs 26L. The bandwidth of each spine-side multiplexer/demultiplexer pair 26S is BW_{S}, while the bandwidth of each leaf-side multiplexer/demultiplexer pair 26L is BW_{L}. In many embodiments, such as the embodiments described above with respect to FIGS. 2-3B, the number M_{S} of spine-side multiplexer/demultiplexer pairs 26S and a number M_{L} of leaf-side multiplexer/demultiplexer pairs 26L are equal to each other. This configuration permits the total bandwidths BW_{S} and BW_{L} to also be equal to each other, thereby simplifying the design of the optical interconnection assembly 60. For example, when the number M_{S} of spine-side multiplexer/demultiplexer pairs 26S and a number M_{L} of leaf-side multiplexer/demultiplexer pairs 26L are equal to each other, multiplexer and demultiplexer components having the same type and configuration may be used in both the uplink and downlink directions.

The spine-side multiplexer/demultiplexer pair bandwidth BW_{S} is related to the number N_{S} of WDM channels (cable pairs 32D/U) at each spine-side multiplexer/demultiplexer pair 26S and to the data rate D carried by each of the cables by the relationship BW_{S}=N_{S}·D. Likewise, the leaf-side multiplexer/demultiplexer pair bandwidth BW_{L} is related to the number N_{L} of WDM channels (cable pairs 32D/U) at each leaf-side multiplexer/demultiplexer pair 26L and to the data rate D carried by each of the cables by the relationship BW_{L}=N_{L}·D.

The spine-side multiplexer/demultiplexer pairs 26S and the leaf-side multiplexer/demultiplexer pairs 26L of optical interconnection assembly 60 are related by the equation

M_{S}·BW_{S}=M_{L}·BW_{L}. (1)

Substituting for BW_{S} and BW_{L} in equation (1) using the above relationship for these terms yields the following relationship:

M_{S}·N_{S}·D=M_{L}·N_{L}·D. (2)

Equation (2) can be simplified into the following relationship:

N_{S}/N_{L}=M_{L}/M_{S}. (3)

Equation (3) represents the basic relationship between the number M_{S} of spine-side multiplexer/demultiplexer pairs 26S, the number M_{L} of leaf-side multiplexer/demultiplexer pairs 26L, and the respective number N_{S} and N_{L} of cable pairs 32D/U at each of the spine-side and leaf-side multiplexer/demultiplexer pairs 26S/L. One or more optical interconnection assemblies 60 that are configured according to equation (3) can be used to scale-out the corresponding S/L network 10.

Table 1 below sets forth three example configurations for optical interconnection assembly 60 based on equation (3).

TABLE 1
Example optical interconnection assembly configurations

| CONFIGURATION | N_{S} | N_{L} | M_{L} | M_{S} |
|---|---|---|---|---|
| EXAMPLE 1 | | | | |
| 40 GbE (4 × 10 GbE) spine-side | 4 | 4 | 4 | 4 |
| multiplexer/demultiplexer pairs | | | | |
| 40 GbE (4 × 10 GbE) leaf-side | | | | |
| multiplexer/demultiplexer pairs | | | | |
| BW_{S} = 40 GbE (4 × 10 GbE) | | | | |
| BW_{L} = 40 GbE (4 × 10 GbE) with D = 10 GbE | | | | |
| EXAMPLE 2 | | | | |
| 120 GbE (12 × 10 GbE) spine-side | 12 | 4 | 12 | 4 |
| multiplexer/demultiplexer pairs | | | | |
| 40 GbE (4 × 10 GbE) leaf-side | | | | |
| multiplexer/demultiplexer pairs | | | | |
| BW_{S} = 120 GbE (12 × 10 GbE) | | | | |
| BW_{L} = 40 GbE (4 × 10 GbE) with D = 10 GbE | | | | |
| EXAMPLE 3 | | | | |
| 400 GbE (16 × 25 GbE) spine-side | 16 | 4 | 16 | 4 |
| multiplexer/demultiplexer pairs | | | | |
| 100 GbE (4 × 25 GbE) leaf-side | | | | |
| multiplexer/demultiplexer pairs | | | | |
| BW_{S} = 400 GbE (16 × 25 GbE) | | | | |
| BW_{L} = 100 GbE (4 × 25 GbE) with D = 25 GbE | | | | |

Thus, three different example configurations for optical interconnection assembly 60 have the following relationships, respectively: 1) BW_{S}=BW_{L} and N_{S}=N_{L}; 2) BW_{S}=3·BW_{L} and N_{S}=3·N_{L}; and 3) BW_{S}=3·BW_{L} and N_{S}=4·N_{L}. It should be understood that Example 1 is a “balanced” configuration, in which N_{S} is equal to N_{L}, while Examples 2 and 3 are “unbalanced” configurations, in which N_{S} may be larger or smaller than N_{L}. In many embodiments, the multiplexing and demultiplexing configuration and cabling complexity for a balanced configuration may be less complex than for an unbalanced configuration, because the number of frequencies required to permit each spine-side multiplexer/demultiplexer pair to communicate with every leaf-side multiplexer/demultiplexer pair is the same in both the uplink and downlink directions.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. An optical interconnection assembly for directing communication signals between spine and leaf connection components of a spine-and-leaf network, the optical interconnection assembly comprising:
a plurality of leaf-side demultiplexers, each having a leaf-side demultiplexer input and a plurality of leaf-side demultiplexer outputs;
a plurality of spine-side multiplexers, each having a plurality of spine-side multiplexer inputs and a spine-side multiplexer output;
a plurality of downlink optical paths, each of the plurality of downlink optical paths optically connected between a leaf-side demultiplexer output to a spine-side multiplexer input, wherein each spine-side multiplexer is configured to receive a component downlink signal on a downlink optical path from every leaf-side demultiplexer and multiplex the received component downlink signals into a multiplexed spine-side downlink signal.

2. The optical interconnection assembly of claim 1, wherein each leaf-side demultiplexer is optically connected to every spine-side multiplexer by at least one downlink optical path;
wherein each leaf-side demultiplexer is configured to:
receive a multiplexed leaf-side downlink signal from a leaf connection component at the leaf-side demultiplexer input;
demultiplex the multiplexed leaf-side downlink signal into a plurality of component downlink signals; and
provide each of the plurality of component downlink signals to a different one of the plurality of downlink optical paths via one of the plurality of leaf-side demultiplexer outputs; and
wherein each spine-side multiplexer is configured to:
receive a component downlink signal at each spine-side multiplexer input via a downlink optical path from one of the leaf-side demultiplexers, such that each spine-side multiplexer receives a component downlink signal from every one of the plurality of leaf-side demultiplexers;
multiplex the received component downlink signals into a multiplexed spine-side downlink signal; and
provide the multiplexed spine-side downlink signal to a spine connection component at the spine-side multiplexer output.

3. The optical interconnection assembly of claim 1, wherein each spine-side demultiplexer is optically connected to every leaf-side multiplexer by at least one uplink optical path;
wherein each spine-side demultiplexer is configured to:
a plurality of spine-side demultiplexers each having a spine-side demultiplexer input and a plurality of spine-side demultiplexer outputs;
a plurality of leaf-side multiplexers, each having a plurality of leaf-side multiplexer inputs and a leaf-side multiplexer output;
a plurality of uplink optical paths, each of the plurality of uplink optical paths optically connected between a spine-side demultiplexer output to a leaf-side multiplexer input such that each spine-side demultiplexer is optically connected to every leaf-side multiplexer by at least one uplink optical path, wherein each the leaf-side multiplexers is configured to receive a component uplink signal on an uplink optical path from every spine-side demultiplexer and multiplex the received component uplink signals into a multiplexed leaf-side uplink signal.

4. The optical interconnection assembly of claim 3, wherein each spine-side demultiplexer is configured to:
receive a multiplexed spine-side uplink signal from a spine connection component at the spine-side multiplexer input;
demultiplex the multiplexed spine-side uplink signal into a plurality of component uplink signals; and
provide each of the plurality of component uplink signals to a different one of the plurality of uplink optical paths via one of the plurality of spine-side demultiplexer outputs; and
wherein each leaf-side multiplexer is configured to:
receive a component uplink signal at each leaf-side multiplexer input via an uplink optical path from one of the spine-side demultiplexers, such that each leaf-side multiplexer receives a component uplink signal from every one of the plurality of spine-side demultiplexers;
multiplex the received component uplink signals into a multiplexed leaf-side uplink signal; and
provide the multiplexed leaf-side uplink signal to a leaf connection component at the leaf-side multiplexer output.

5. The optical interconnection assembly of claim 3, wherein each spine-side multiplexer corresponds to a spine-side demultiplexer, thereby forming a plurality of spine-side multiplexer/demultiplexer pairs, and each leaf-side multiplexer corresponds to a leaf-side demultiplexer, thereby forming a plurality of leaf-side multiplexer/demultiplexer pairs.

6. The optical interconnection assembly of claim 5, wherein each multiplexer/demultiplexer pair is a wave division multiplexer/demultiplexer pair.

7. The optical interconnection assembly of claim 5, wherein each multiplexer/demultiplexer pair comprises at least one fiber optic connector for connecting to at least one fiber optic cable to communicate with one of a leaf connection component and a spine connection component.

8. The optical interconnection assembly of claim 5, wherein the at least one fiber optic connector comprises a pair of simplex fiber optic connectors.

9. The optical interconnection assembly of claim 5, wherein the at least one fiber optic connector comprises a duplex fiber optic connector.

10. The optical interconnection assembly of claim 5, further comprising a housing having a plurality of fiber optic adapters, each fiber optic adapter configured to optically connect to at least one of the fiber optic connectors.

11. The optical interconnection assembly of claim 10, wherein the optical interconnection assembly is a fiber optic module, and wherein the housing comprises a housing containing the plurality of downlink and uplink paths.

12. The optical interconnection assembly of claim 5, wherein the number of spine-side multiplexer/demultiplexer pairs is equal to the number of leaf-side multiplexer/demultiplexer pairs.

13. The optical interconnection assembly of claim 12, wherein the number of spine-side multiplexer/demultiplexer pairs is four (4) and the number of leaf-side multiplexer/demultiplexer pairs is four (4).

14. The optical interconnection assembly of claim 5, wherein each multiplexed downlink and uplink signal is a 40 Gigabit (GbE) signal and each component downlink and uplink signal is a 10 GbE signal.

15. A spine and leaf (S/L) network comprising:
at least one leaf switch each having a plurality of leaf connection components;
a plurality of spine switches each having a plurality of spine connection components; and
at least one optical interconnection assembly for directing communication signals between spine and leaf connection components of the spine-and-leaf network, each optical interconnection assembly comprising:
a plurality of leaf-side demultiplexers each having a leaf-side demultiplexer input and a plurality of leaf-side demultiplexer outputs;
a plurality of spine-side multiplexers, each having a plurality of spine-side multiplexer inputs and a spine-side multiplexer output;
a plurality of downlink optical paths, each of the plurality of downlink optical paths optically connected between a leaf-side demultiplexer output to a spine-side multiplexer input such that each leaf-side demultiplexer is optically connected to every spine-side multiplexer by at least one downlink optical path, wherein each spine-side multiplexer is configured to receive a component downlink signal on a downlink optical path from every leaf-side demultiplexer and multiplex the received component downlink signals into a multiplexed spine-side downlink signal.

16. The S/L network of claim 15, wherein each leaf-side demultiplexer is optically connected to every spine-side multiplexer by at least one downlink optical path;
wherein each leaf-side demultiplexer is configured to:
receive a multiplexed leaf-side downlink signal from a leaf connection component at the leaf-side demultiplexer input;
demultiplex the multiplexed leaf-side downlink signal into a plurality of component downlink signals; and
provide each of the plurality of component downlink signals to a different one of the plurality of downlink optical paths via one of the plurality of leaf-side demultiplexer outputs; and
wherein each spine-side multiplexer is configured to:
receive a component downlink signal at each spine-side multiplexer input via a downlink optical path from one of the leaf-side demultiplexers, such that each spine-side multiplexer receives a component downlink signal from every one of the plurality of leaf-side demultiplexers;
multiplex the received component downlink signals into a multiplexed spine-side downlink signal; and
provide the multiplexed spine-side downlink signal to a spine connection component at the spine-side multiplexer output.

17. The S/L network of claim 15, wherein each optical interconnection assembly further comprises:
a plurality of spine-side demultiplexers each having a spine-side demultiplexer input and a plurality of spine-side demultiplexer outputs;
a plurality of leaf-side multiplexers, each having a plurality of leaf-side multiplexer inputs and a leaf-side multiplexer output;
a plurality of uplink optical paths, each of the plurality of uplink optical paths optically connected between a spine-side demultiplexer output to a leaf-side multiplexer input, wherein each the leaf-side multiplexers is configured to receive a component uplink signal on an uplink optical path from every spine-side demultiplexer and multiplex the received component uplink signals into a multiplexed leaf-side uplink signal.

18. The S/L network of claim 17, wherein that each spine-side demultiplexer is optically connected to every leaf-side multiplexer by at least one uplink optical path wherein each spine-side demultiplexer is configured to:
receive a multiplexed spine-side uplink signal from a spine connection component at the spine-side multiplexer input;
demultiplex the multiplexed spine-side uplink signal into a plurality of component uplink signals; and
provide each of the plurality of component uplink signals to a different one of the plurality of uplink optical paths via one of the plurality of spine-side demultiplexer outputs; and
wherein each leaf-side multiplexer is configured to:
receive a component uplink signal at each leaf-side multiplexer input via an uplink optical path from one of the spine-side demultiplexers, such that each leaf-side multiplexer receives a component uplink signal from every one of the plurality of spine-side demultiplexers;
multiplex the received component uplink signals into a multiplexed leaf-side uplink signal; and
provide the multiplexed leaf-side uplink signal to a leaf connection component at the leaf-side multiplexer output.

19. The S/L network of claim 17, wherein each spine-side multiplexer corresponds to a spine-side demultiplexer, thereby forming a plurality of spine-side multiplexer/demultiplexer pairs, and each leaf-side multiplexer corresponds to a leaf-side demultiplexer, thereby forming a plurality of leaf-side multiplexer/demultiplexer pairs.

20. The S/L network of claim 19, wherein each multiplexer/demultiplexer pair is a wave division multiplexer/demultiplexer pair.

21. The S/L network of claim 19, wherein each multiplexer/demultiplexer pair comprises at least one fiber optic connector for connecting to at least one fiber optic cable to communicate with one of a leaf connection component and a spine connection component.

22. The S/L network of claim 21, wherein the at least one fiber optic connector comprises a pair of simplex fiber optic connectors.

23. The S/L network of claim 21, wherein the at least one fiber optic connector comprises a duplex fiber optic connector.

24. The S/L network of claim 23, wherein the at least one optical interconnection assembly compries at least one housing having a plurality of fiber optic adapters, each fiber optic adapter configured to optically connect to at least one of the fiber optic connectors.

25. The S/L network of claim 24, wherein the at least one optical interconnection assembly comprises at least one fiber optic module, and wherein the at least one housing comprises a housing containing the plurality of downlink and uplink paths.

26. The S/L network of claim 19, wherein, for each optical interconnection assembly, the number of spine-side multiplexer/demultiplexer pairs is equal to the number of leaf-side multiplexer/demultiplexer pairs.

27. The S/L network of claim 26, wherein, for each optical interconnection assembly, the number of spine-side multiplexer/demultiplexer pairs is four (4) and the number of leaf-side multiplexer/demultiplexer pairs is four (4).

28. The S/L network of claim 19, wherein each multiplexed downlink and uplink signal is a 40 Gigabit (GbE) signal and each component downlink and uplink signal is a 10 GbE signal.

29. A method of directing communication signals between spine and leaf connection components of a spine-and-leaf network comprising:
receiving a multiplexed leaf-side downlink signal from a leaf connection component at one of a plurality of leaf-side demultiplexer inputs of a plurality of leaf-side demultiplexers of an optical interconnection assembly;
demultiplexing each multiplexed leaf-side downlink signal into a plurality of component downlink signals;
providing each of the plurality of component downlink signals to a different one of a plurality of downlink optical paths of the optical interconnection assembly via one of a plurality of leaf-side demultiplexer outputs of the optical interconnection assembly;
receiving a component downlink signal at each one of a plurality of spine-side multiplexer inputs of a plurality of spine-side multiplexers of the optical interconnection assembly via a downlink optical path from one of the leaf-side demultiplexers, such that each spine-side multiplexer receives a component downlink signal from every one of the plurality of leaf-side demultiplexers;
multiplexing, at each spine-side multiplexer, the received component downlink signals into a multiplexed spine-side downlink signal; and
providing each multiplexed spine-side downlink signal to a spine connection component at the spine-side multiplexer output.

30. The method of claim 29, further comprising:
receiving a multiplexed spine-side uplink signal from a spine connection component at one of a plurality of spine-side demultiplexer inputs of a plurality of spine-side demultiplexers of the optical interconnection assembly;
demultiplexing each multiplexed spine-side uplink signal into a plurality of component uplink signals;
providing each of the plurality of component uplink signals to a different one of a plurality of uplink optical paths of the optical interconnection assembly via one of a plurality of spine-side demultiplexer outputs of the optical interconnection assembly;
receiving a component uplink signal at each one of a plurality of leaf-side multiplexer inputs of a plurality of leaf-side multiplexers of the optical interconnection assembly via an uplink optical path from one of the spine-side demultiplexers, such that each leaf-side multiplexer receives a component uplink signal from every one of the plurality of spine-side demultiplexers;
multiplexing, at each leaf-side multiplexer, the received component uplink signals into a multiplexed leaf-side uplink signal; and
providing each multiplexed leaf-side uplink signal to a leaf connection component at the leaf-side multiplexer output.

31. The method of claim 30, wherein multiplexing/demultiplexing the uplink and downlink optical signals comprises wave division multiplexing/demultiplexing.

32. An optical interconnection assembly for directing communication signals between spine and leaf connection components of a spine-and-leaf network, the optical interconnection assembly comprising:
a plurality of spine-side demultiplexers, each having a spine-side demultiplexer input and a plurality of spine-side demultiplexer outputs;
a plurality of leaf-side multiplexers, each having a plurality of leaf-side multiplexer inputs and a leaf-side multiplexer output;
a plurality of uplink optical paths, each of the plurality of uplink optical paths optically connected between a spine-side demultiplexer output to a leaf-side multiplexer input, wherein each leaf-side multiplexer is configured to receive a component uplink signal on an uplink optical path from every spine-side demultiplexer and multiplex the received component uplink signals into a multiplexed leaf-side uplink signal.
